(19) United States
(12) Patent Application Publication
(10) Pub. No.: US 2009/0325581 A1
(43) Pub. Date: Dec. 31, 2009

(54) METHOD AND APPARATUS FOR DYNAMIC MOBILE PROFILE FUNCTIONALITY

(75) Inventors: Guang Lu, Montreal (CA); Michelle Perras, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/485,137

(22) Filed: Jun. 16, 2009

Related U.S. Application Data
(60) Provisional application No. 61/061,764, filed on Jun. 16, 2008.

(51) Int. Cl. H04W 36/00

(52) U.S. Cl. 455/436

(57) ABSTRACT

A method and apparatus provide dynamic mobile profile functionality in a media independent handover. This may include an MIH server dynamically changing a mobile profile in an MIH client.

### CROSS REFERENCE TO RELATED APPLICATIONS

This application claims the benefit of U.S. Provisional Application No. 61/061,764 filed on Jun. 16, 2008, which is incorporated by reference as if fully set forth.

### TECHNOLOGY FIELD

This application is related to wireless communications.

### BACKGROUND

IEEE 802.21 MIH (Media Independent Handover) defines a framework for supporting handover between heterogeneous access networks. The MIH functionalities reside on the network side (MIH server) and on the wireless transmit receive unit (WTRU)/MIH client side. Handover may be MIH server initiated or MIH client initiated.

The MIH server may control the handover from one technology to another by sending a Handover Request to the MIH client, and the MIH client may execute the handover command. The MIH server may make the handover decision based on its own policy with input (for example, measurement reports) from the MIH client or without input from the MIH client (for example, for immediate load balancing).

A WTRU may have a predefined preferred network specified in its mobile profile. The MIH client may try to handover to the preferred network (monitor the link quality and send measurements to the MIH server). A mobile profile may be saved locally (for example, on a subscriber identity module (SIM) card or on a personal computer (PC)).

As shown in FIG. 1, in the current 802.21 standard, the MIH server does not have the ability to change the mobile profile. The scenario shown in FIG. 1 only allows MIH server initiated handover. In a case where the MIH server desires the WTRU to stay in a non-preferred network for load balancing purposes, the MIH server will not initiate a handover and the WTRU will continue to scan for its preferred network and send measurements. In this scenario, radio resources, battery power and central processor unit (CPU) cycles are wasted due to unnecessary scanning and measurement report transmissions and WTRU initiated handover is not allowed. Since WTRU initiated handover is not allowed, the WTRU must wait for the handover (HO) command from the MIH server.

As shown in FIG. 2, the MIH server may initiate handover to a non-preferred network for load balancing purposes. The MIH client may attempt to perform a handover back to the preferred network by monitoring the preferred network link quality. The WTRU periodically scans the preferred network to discover if coverage is available (only reception (RX) enabled). If the preferred network is available and a mobile initiated handover is allowed, no measurements need to be sent to the server, and the mobile will initiate a handover to its preferred network. This may create a ping-pong situation that occurs due to contradictory handover preference between the MIH server and the MIH client.

As shown in FIG. 3, the MIH server may initiate handover from network A to network B when the WTRU is about to lose connectivity on network A. If network A is the preferred network, the MIH server initiates a handover back to network A as soon as network A becomes available. The handover may occur back and forth between network A and network B due to the static policy defining a preferred network.

FIG. 4 is diagram of an example of network architecture for wireless systems capable of supporting inter-technology handover. These underlying technologies may include for example Third Generation Partnership Project (3GPP), 3GPP2 and IEEE-based networks such as IEEE 802.xx, code division multiple access (CDMA) 2000; universal mobile telephone system (UMTS), GSM, long term evolution (LTE) or any other wireless communication system including future wireless communication systems not yet developed.

### SUMMARY

A method and apparatus provide dynamic mobile profile functionality in a media independent handover. This may include an MIH server dynamically changing a mobile profile in an MIH client.

The method may be performed by a wireless transmit/receive unit (WTRU) by scanning for a preconfigured preferred network, receiving a request to change the preconfigured preferred network to the non-preferred network, and setting the preconfigured preferred network to the non-preferred network.

The apparatus may be a WTRU that includes a receiver configured to receive a new mobile profile on a current network, and a media independent handover (MIH) client. The MIH client may be configured to determine whether a preferred network has changed, determine whether an associated weight has changed when the preferred network has not changed, and scan at a predetermined interval to detect the preferred network when the current network is not the preferred network.

### BRIEF DESCRIPTION OF THE DRAWINGS

A more detailed understanding may be had from the following description, given by way of example in conjunction with the accompanying drawings wherein:

FIG. 1 is a signal diagram illustrating unnecessary scanning in accordance with the prior art;

FIG. 2 is a signal diagram illustrating a ping-pong situation in accordance with the prior art;

FIG. 3 is a signal diagram illustrating frequent handovers in accordance with the prior art;

FIG. 4 is a diagram of an example network architecture for wireless systems capable of supporting inter-technology handover;

FIG. 5 is a signal diagram of an example procedure to prevent an MIH client of a WTRU from unnecessary scanning;

FIG. 6 is a signal diagram of an example procedure to prevent an MIH client of a WTRU from a ping-pong situation;

FIG. 7 is a signal diagram of an example procedure to optimize handovers between two networks using a weight factor;

FIG. 8 is a flow diagram of a procedure initiated in a WTRU when a new mobile profile is received from an MIH server;

FIG. 9 is a flow diagram of a procedure initiated in a WTRU when a new mobile profile is received from an MIH server;

FIG. 10 is a diagram of an example CAPABILITY_DISCOVERY request/response message;

FIG. 11 is a diagram of an example MIH_CONFIGURE_PROFILE request message;

FIG. 12 is a diagram of an example MIH_CONFIGURE_PROFILE response message;

FIG. 13 is a diagram of an example CAPABILITY_DISCOVERY request/response message;

FIG. 14 is a diagram of an example MIH_GET_INFORMATION response message; and

FIG. 15 is a block diagram of an example system configured to perform a media independent handover.

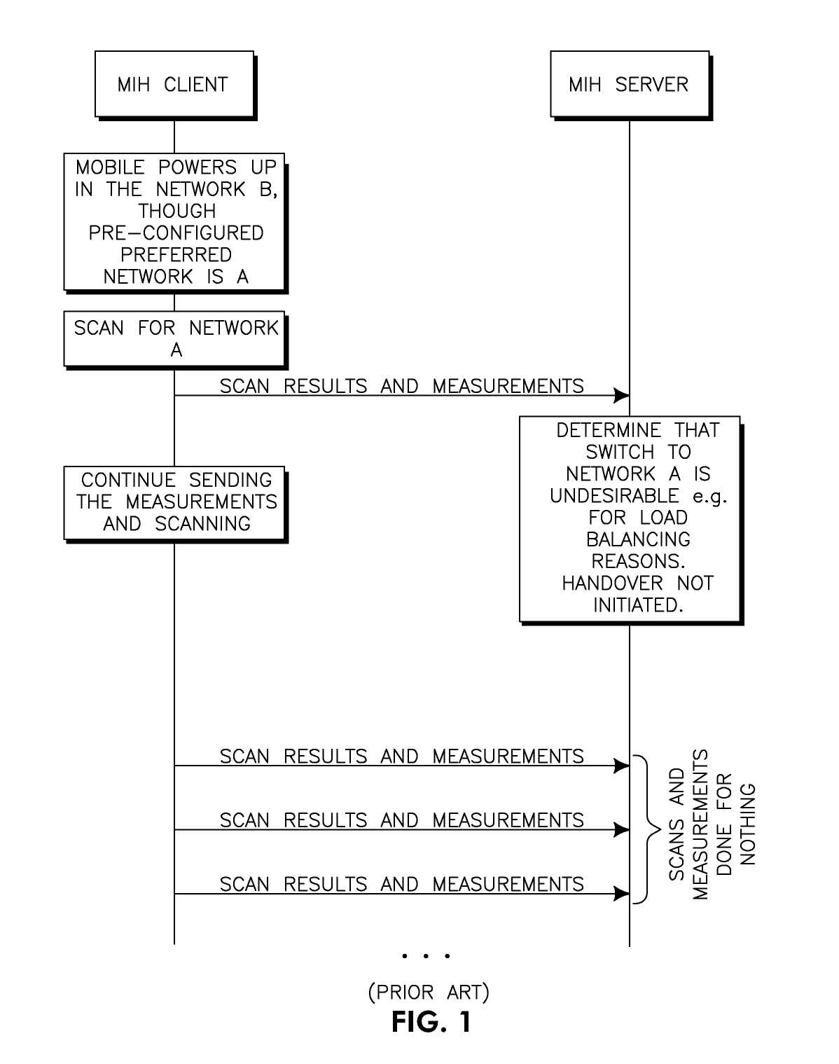

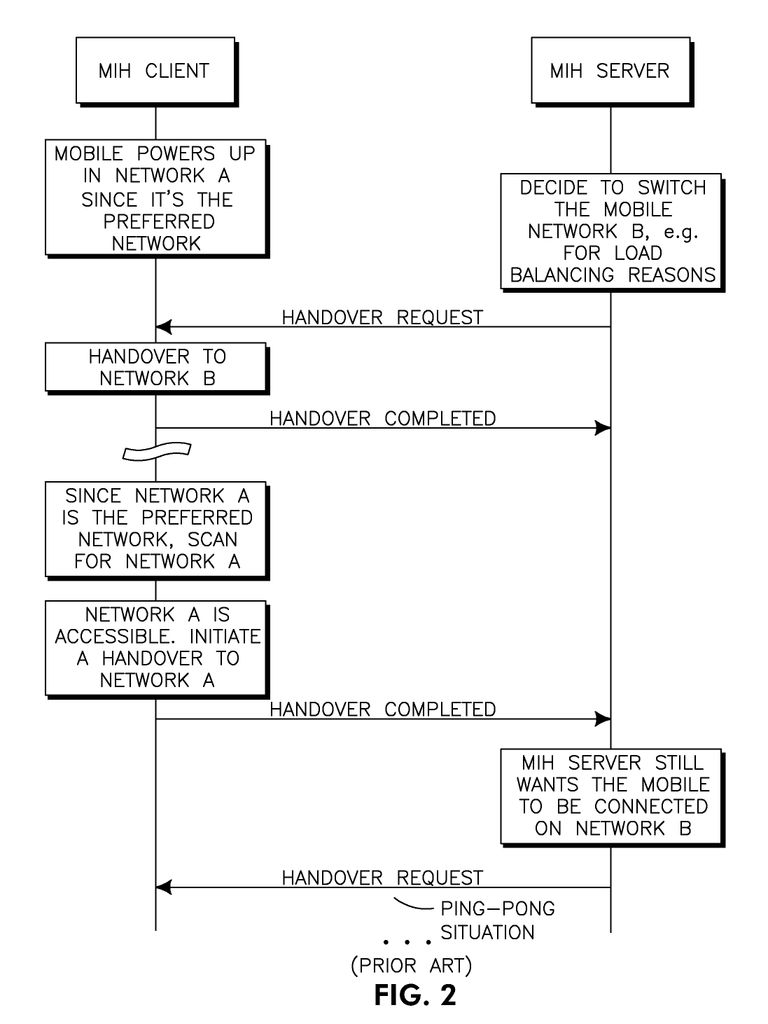

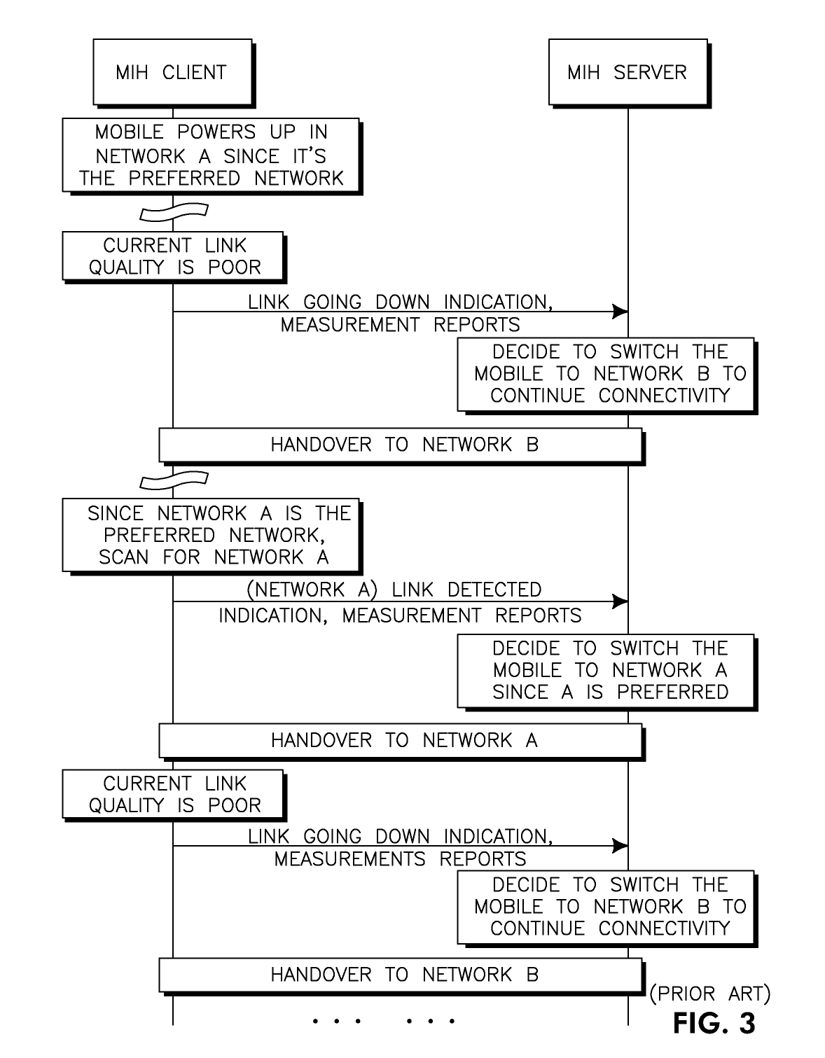

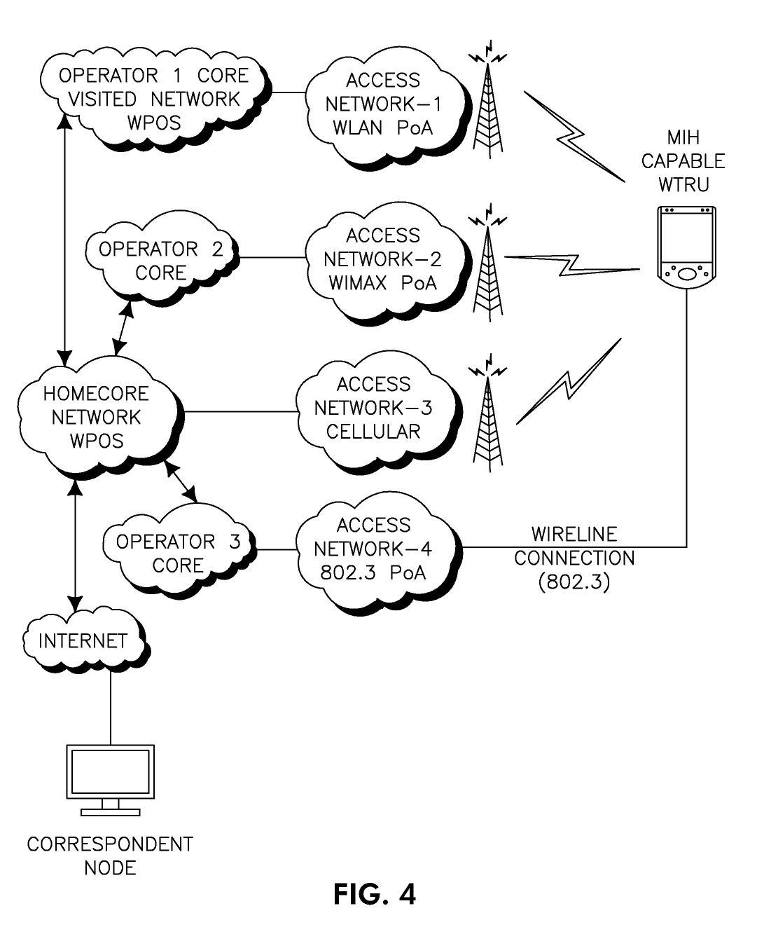

### DETAILED DESCRIPTION

When referred to herein, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to herein, the terminology “base station” includes but is not limited to a Node-B, a site controller, an access point (AP), or any other type of interfacing device capable of operating in a wireless environment.

MIH may be improved by allowing an MIH server to dynamically change a mobile profile or policies associated with a WTRU. More specifically, a preferred network may be dynamically configured. Furthermore, other mobile profile information may be exchanged using the same mechanism, for example, the mobility operational state, which enables/disables WTRU mobility. For simplicity, examples for changing a mobile profile or policies are discussed in the context of preferred network, associated weight, and operational state. It is understood that any other parameter from the mobile profile may be dynamically configured in accordance with the examples described herein, and should not be limited to the preferred network, associated weight, and operational state.

An MIH server may dynamically configure the MIH client mobile profile or policies to dynamically control WTRU behavior. The preferred network and the mobility operational state may be changed at any time using a variety of mechanisms including, for example, a push mechanism.

A variety of mechanisms may be used to change a user's preferred network dynamically. For example, the preferred network may be configured with a different weight. The network preference level may be dynamically changed based on input from user activity statistics. The mobile profile may be adapted to optimize the radio resource usage and to improve the mobile user's experience. MIH messages may be exchanged between the MIH server and the MIH client.

In another example, mobility features may be enabled or disabled dynamically. This may apply to MIH server initiated and MIH client initiated handover and may apply to multi-radio devices.

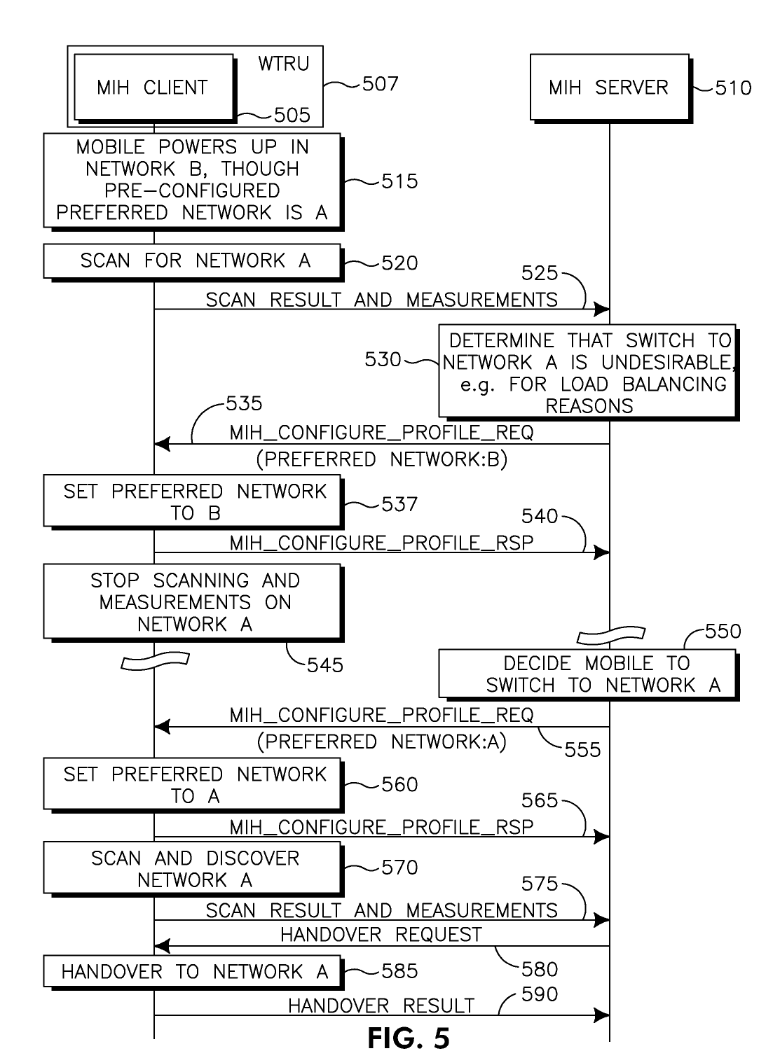

FIG. 5 is a signal diagram of an example procedure to prevent an MIH client 505 of a WTRU 507 from unnecessary scanning. In this example, the WTRU's 507 preconfigured preferred network is network A. When the WTRU 507 powers up in network B 515, the MIH client 505 scans for network A 520. The MIH client 505 then sends the scan result and measurements 525 to the MIH server 510.

An MIH server 510 receives the scan result and measurements and determines that the WTRU 507 should remain in a non-preferred network (network B) for example, for load balancing purposes 530. The MIH server 510 changes the mobile profile and sends an MIH_CONFIGURE_PROFILE_REQ message 535 to the MIH client 505 to indicate that the new preferred network is network B. Upon receiving the MIH_CONFIGURE_PROFILE_REQ, the MIH client 505 sets the preferred network to network B 537 and sends an MIH_CONFIGURE_PROFILE_RSP message 540 to the MIH server 510. The MIH client 505 may then stop scanning and sending measurements on network A 545 to conserve battery power, radio resources and CPU cycles.

At a later time, the MIH server 510 may decide to switch the MIH client to network A 550. The MIH server 510 then sends an MIH_CONFIGURE_PROFILE_REQ message 555 to the MIH client 510 to indicate that the new preferred network is network A. Upon receiving the MIH_CONFIGURE_PROFILE_REQ message, the MIH client 505 sets the preferred network to network A 560 and sends an MIH_CONFIGURE_PROFILE_RSP message 665 to the MIH server 510. The MIH client 505 then scans and discovers network A 570 and sends the scan results and measurements 575 to the MIH server 510. The MIH server 510 in turn sends a handover request 580 to the MIH client 505. The MIH client 505 then performs a handover to network A 585 and sends a handover result 590 to the MIH server 510.

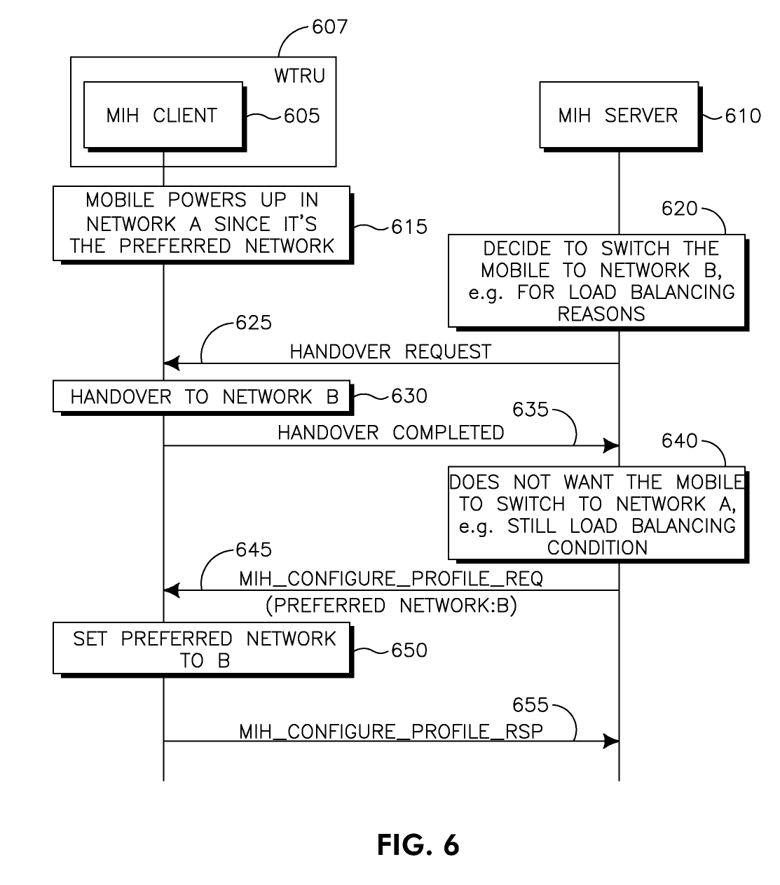

FIG. 6 is a signal diagram of an example procedure to prevent an MIH client 605 of a WTRU 607 from a ping-pong situation. In this example, the MIH client's 605 preconfigured preferred network is network A and the WTRU 607 powers up in network A 615.

An MIH server 610 determines that the WTRU 607 should switch to a non-preferred network (network B) for load balancing purposes 620. The MIH server 610 sends a handover request message 625 to the MIH client 605. Upon receiving the handover request message 625, the MIH client 605 performs a handover to network B 630 and sends a handover completed message 635 to the MIH server 610. Upon receiving the handover completed message 635, the MIH server 610 may determine that the WTRU 607 should remain on network B 640 based on, for example, load balancing reasons. The MIH server 610 may then send an MIH_CONFIGURE_PROFILE_REQ message 645 to the MIH client 605 to indicate that the new preferred network is network B. Upon receiving the MIH_CONFIGURE_PROFILE_REQ message 645, the MIH client 605 sets the preferred network to network B 650 and sends an MIH_CONFIGURE_PROFILE_RSP message 655 to the MIH server 610. Since network B is now the preferred network, no handover is initiated and the ping-pong situation is avoided.

A weight factor may be added to the dynamic mobile profile for preferred networks. A list of supported networks may be assigned a weight factor, for example (w1)Network1, (w2)Network2, etc. The weight factor may be implemented by using integers to allow for fine tuning. The weight factor may also be implemented by using scales, such as high, medium, and low to allow for simple implementation.

The WTRU may be configured to react to the changed network preference or weight of the preference. For example, if the weight is decreased for a network, the WTRU may increase the interval of scanning of this network, or stop scanning. The WTRU may also increase the time of Low Power mode (idle mode) for the modem. If the weight is increased, the WTRU may wake up the modem if it is in idle mode, and start scanning the network with high preference, or it may decrease the interval of scanning.

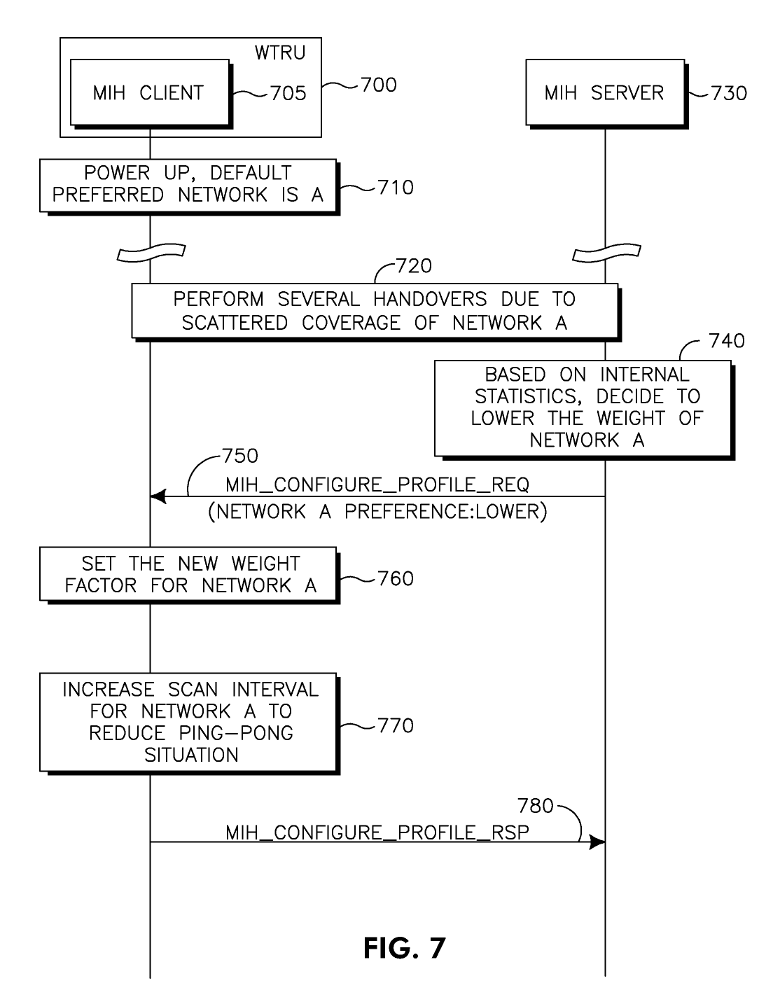

FIG. 7 is a signal diagram of an example procedure to optimize handovers between two networks using a weight factor. In this example, a WTRU 700 that includes an MIH client 705, is preconfigured as network A being the preferred network. The WTRU 700 powers up in an area with scattered coverage of network A 710, which results in several handovers 720. An MIH server 730, determines to reduce the weight of network A based on internal statistics 740. The MIH server 730 then sends an MIH_CONFIGURE_PROFILE_REQ message 750 to the MIH client 705. The MIH client 705 then sets a new weight factor for network A 760 and increases the scan interval for network A to reduce the occurrence of a ping-pong situation 770. The MIH client 705 may then send an MIH_CONFIGURE_PROFILE_RSP message 780 to the MIH server 730.

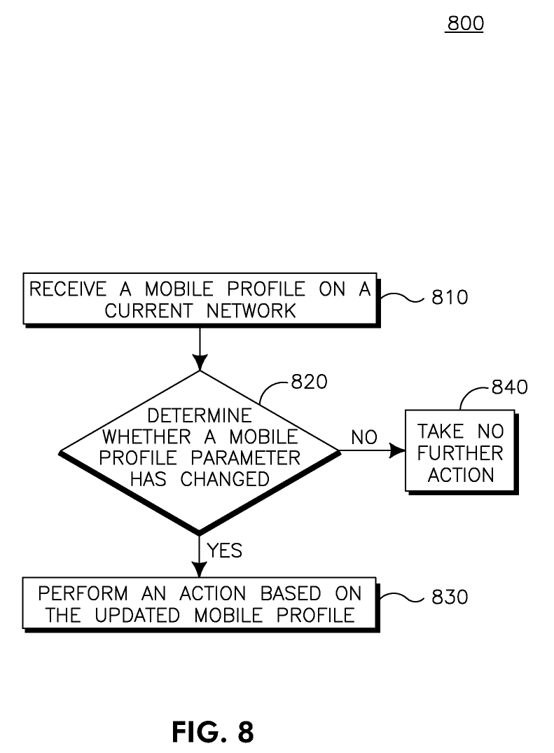

FIG. 8 is a flow diagram 800 of a general procedure initiated in a WTRU when a mobile profile is received from an MIH server. Referring to FIG. 8, when a WTRU receives a mobile profile 810, it may determine whether a mobile profile parameter has changed 820. If a mobile profile parameter has changed, the WTRU may perform an action based on the updated mobile profile 830. If the mobile profile parameters have not changed, the WTRU does not take any action 840. Examples of a change in a mobile profile parameter may be a change in the preferred network, associated weight, operational state, or any other parameter from the mobile profile that may be dynamically configured.

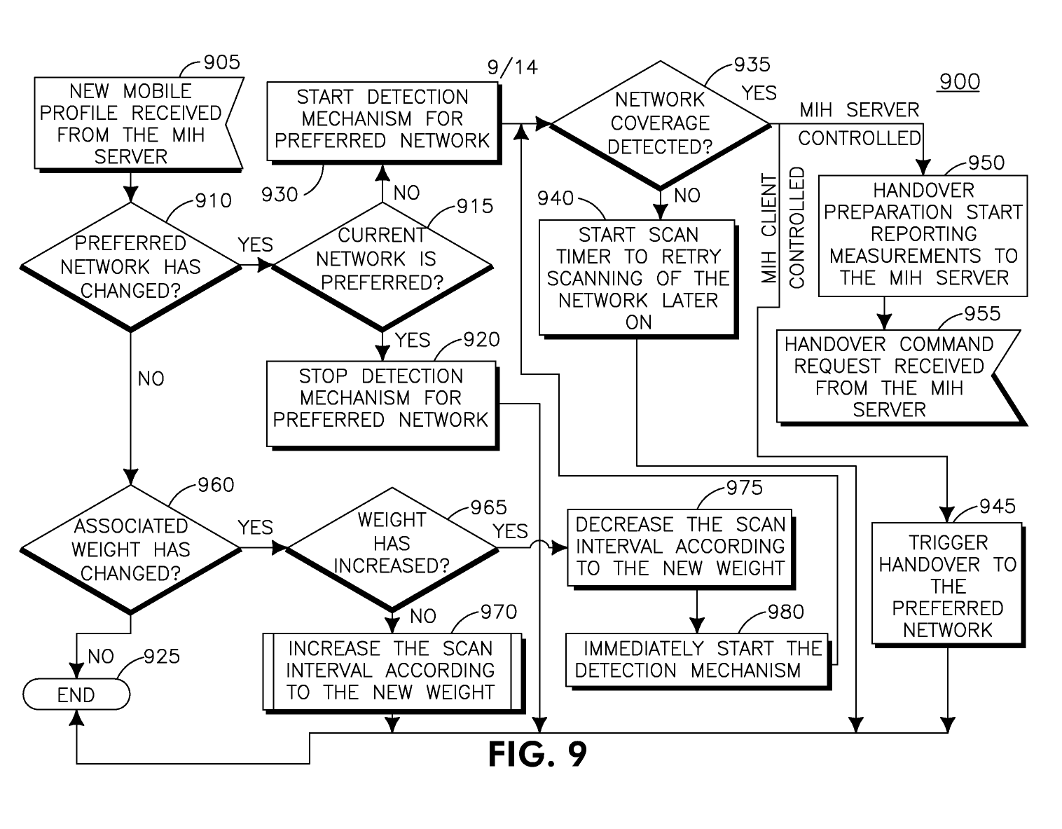

FIG. 9 is a flow diagram 900 of an example procedure initiated in a WTRU when a new mobile profile is received from an MIH server. Upon receiving a new mobile profile from the MIH server 905, the MIH client determines whether the preferred network has changed 910. If the preferred network has changed, the MIH client determines whether the current network is the preferred network 915. If the current network is the preferred network, the MIH client stops the detection mechanism for the preferred network 920 and the procedure ends 925.

If the current network is not the preferred network 915, the MIH client starts the detection mechanism for the preferred network 930. The MIH client then determines whether network coverage is detected 935. If network coverage is not detected, the MIH client starts a scan timer to retry scanning of the network at a later time 940 and the procedure ends 925. If network coverage is detected and the handover is controlled by the MIH client, the MIH client triggers the handover to the preferred network 945 and the procedure ends 925. If network coverage is detected and the handover is controlled by the MIH server, the MIH client reports measurements to the MIH server 950. The MIH server then sends a handover command request to the MIH client 955. The MIH client then triggers a handover to the preferred network 945 and the procedure ends 925.

If the preferred network is not changed 910, the MIH client determines whether an associated weight has changed 960. If the associated weight has not changed, the procedure ends 925. If the associated weight has changed, the MIH client determines whether the weight has increased 965. If the associated weight has decreased, the MIH client increases the scan interval according to the new weight 970 and the procedure ends 925. If the weight has increased, the MIH client decreases the scan interval according to the new weight 975 and immediately starts the detection mechanism 980. Once the detection mechanism has started, the MIH client may continue the network coverage detection procedure 935 as described above.

In addition to changing the preferred network, the MIH server may change the mobility operational state. The mobility operational state is part of the mobile profile. A dynamic mobile profile configuration mechanism may be used to change the mobility operational state or any other parameter of the mobile profile. Setting the mobility operational state to “disable” halts the mobility feature for a configurable amount of time. Setting the mobility operational state to “enable” restarts the mobility feature.

One example for dynamically changing the mobile profile may be through the use of a command service. In this example, the MIH server sends a unicast request to configure the mobile profile and the WTRU sends back a response. The MIH server may also send a broadcast or multicast request to reach multiple users with a single message.

In the command service example, the MIH_CAPABILITY_DISCOVER request/response messages may be modified such that the MIH server discovers whether the MIH client supports dynamic mobile profile configuration. The MIH server may include a CONFIGURE_PROFILE_REQUEST information element in the MIH_CAPABILITY_DISCOVER response message if the MIH client has advertised that it supports dynamic mobile profile configuration in the MIH_CAPABILITY_DISCOVER request message.

Alternatively, new messages may be used in the command service example. These messages may be referred to as MIH_CONFIGURE_PROFILE request/response messages and may include the CONFIGURE_PROFILE_REQUEST information element. In this alternative, the MIH_CONFIGURE_PROFILE request is sent from the MIH server to the MIH client and the MIH_CONFIGURE_PROFILE response is sent from the MIH client to the MIH server.

In another example, the mobile profile may be changed through the use of an information service. In this example, an information server may send a unicast unsolicited information service response that includes the new mobile profile configuration to the WTRU. The information server may also send a broadcast or multicast request to reach multiple users with a single message.

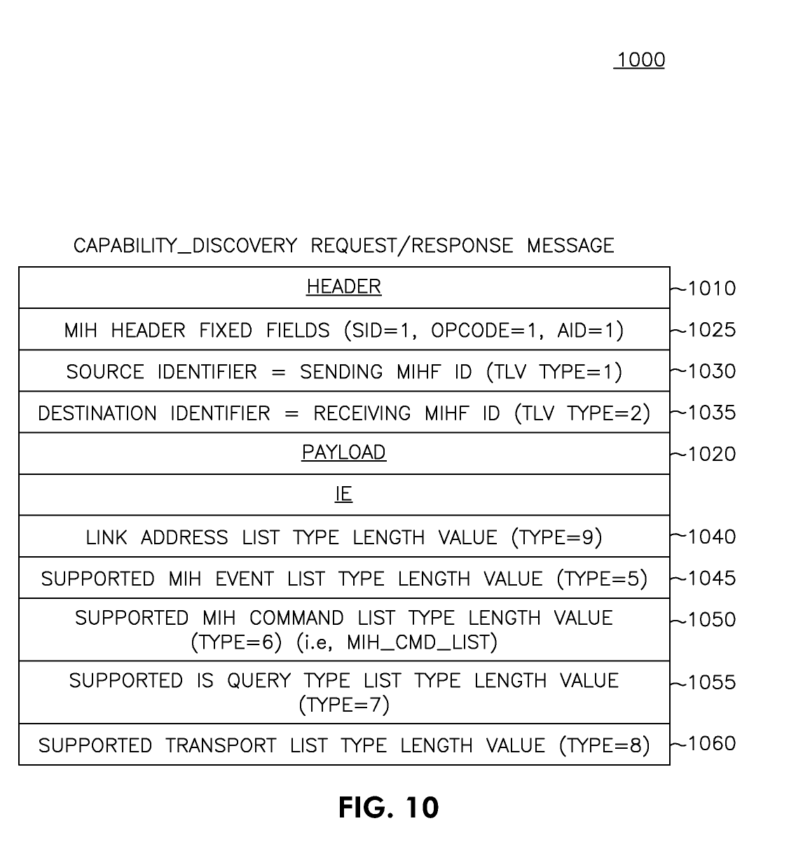

FIG. 10 is a diagram of an example CAPABILITY_DISCOVERY request/response message 1000. The CAPABILITY_DISCOVERY request/response message 1000 may contain a header 1010 and a payload 1020. The header 1010 may contain an MIH Header Fixed Field 1025, a Source Identifier 1030 for sending an MIHF identity (ID), or a Destination Identifier 1035 for receiving an MIHF ID. The payload 1020 may contain at least one of the following information elements: a Link Address List Type Length Value (TLV) 1040 that represents a link address for a specific network type, a Supported MIH Event List TLV 1045 that indicates supported MIH events for a link, a Supported MIH Command List TLV 1050 that indicates support for modified MIH commands, for example an MIH_CMD_LIST, for a link, a Supported IS Query Type List TLV 1055 that indicates support for information services query for a link, and a Supported Transport List TLV 1060 that indicates transport options for MIH services for a link.

The MIH_CMD_LIST command may be four octets in length and contain the following bitmap values as shown in Table 1 below. The MIH_CMD_LIST command may include a MIH-Configure_Profile bit to indicate that mobile profile configurability is supported.

TABLE 1

| Bit | Bitmap Value |
|---|---|
| Bit 0 | MIH_Link_Get_Parameters |
| Bit 1 | MIH_Link_Configure_Thresholds |
| Bit 2 | MIH_Link_Actions |
| Bit 3 | MIH_Net_HO_Candidate_Query |
| | MIH_Net_HO_Commit |
| | MIH_N2N_HO_Query_Resources |
| | MIH_N2N_HO_Commit |
| | MIH_N2N_HO_Complete |
| Bit 4 | MIH_MN_HO_Candidate_Query |
| | MIH_MN_HO_Commit |
| | MIH_MN_HO_Complete |
| Bit 5-30 | (Reserved) |
| Bit 31 | MIH_Configure_Profile |

An Action Identifier (AID) for the MIH_Configure Profile may be defined as shown in Table 2 below. The AID may be any integer value and the values in Table 2 below are shown for illustrative purposes. The AID is part of the MIH protocol header and indicates the action to be taken with regard to the MIH services (i.e. MIH Event, Command, Information, management services). There is a unique AID for each type of service.

TABLE 2

| | |
|---|---|
| MIH Message | AID |

MIH Messages For Service Management

| | |
|---|---|
| MIH_Capability_Discover | 1 |
| MIH_Register | 2 |
| MIH_Deregister | 3 |
| MIH_Event_Subscribe | 4 |
| MIH_Event_Unsubscribe | 5 |

MIH Messages For Event Service

| | |
|---|---|
| MIH_Link_Detected | 1 |
| MIH_Link_Up | 2 |
| MIH_Link_Down | 3 |
| MIH_Link_Parameters_Report | 5 |
| MIH_Link_Going_Down | 6 |
| MIH_Link_Handover_Imminent | 7 |
| MIH_Link_Handover_Complete | 8 |

MIH Messages For Command Service

| | |
|---|---|
| MIH_Link_Get_Parameters | 1 |
| MIH_Link_Configure_Thresholds | 2 |
| MIH_Link_Actions | 3 |
| MIH_Net_HO_Candidate_Query | 4 |
| MIH_MN_HO_Candidate_Query | 5 |
| MIH_N2N_HO_Query_Resources | 6 |
| MIH_MN_HO_Commit | 7 |
| MIH_Net_HO_Commit | 8 |
| MIH_N2N_HO_Commit | 9 |
| MIH_MN_HO_Complete | 10 |
| MIH_N2N_HO_Complete | 11 |
| MIH_Configure_Profile | 12 |

MIH Messages For Information Service

| | |
|---|---|
| MIH_Get_Information | 1 |
| MIH_Push_Information | 2 |

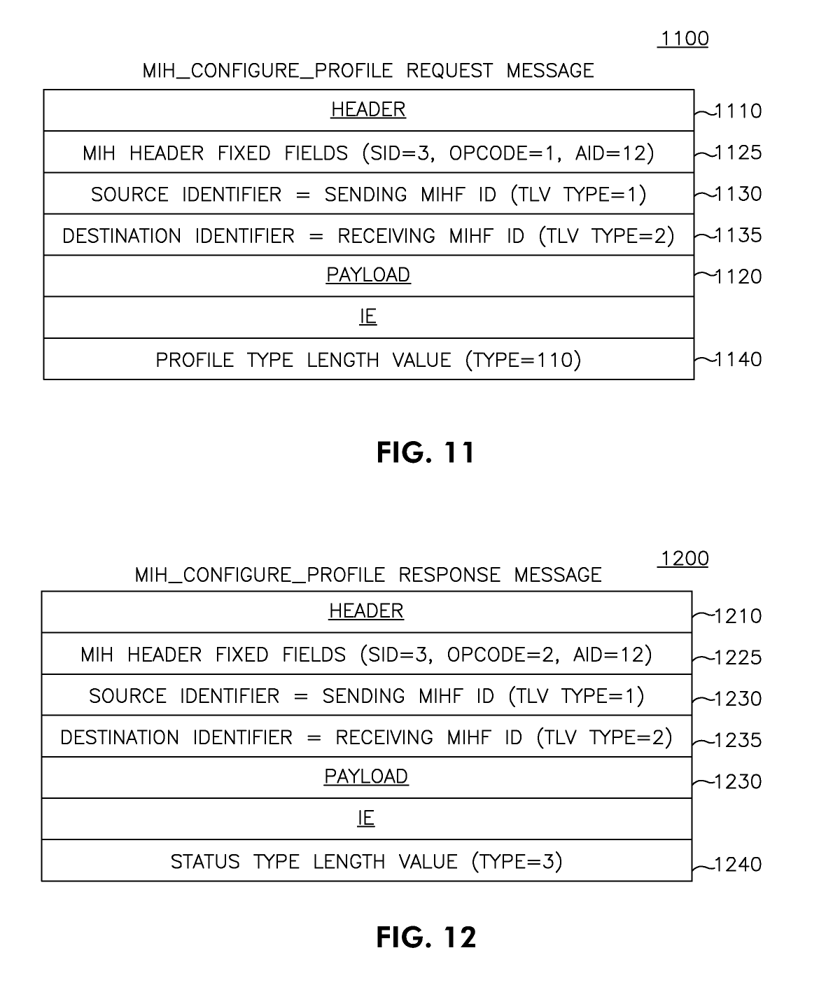

FIG. 11 is a diagram of an example MIH_CONFIGURE_PROFILE request message 1100. The MIH_CONFIGURE_PROFILE request message 1100 may contain a header 1110 and a payload 1120. The header 1110 may contain an MIH Header Fixed Field 1125, a Source Identifier 1130 for sending MIHF identity (ID), or a Destination Identifier 1135 for receiving MIHF ID. The payload 1120 may contain a Profile TLV information element 1140 that identifies the priorities between the supported networks. The priorities may be listed in decreasing order, such that the first network specified is the preferred network.

The MIH_CONFIGURE_PROFILE request may be defined as shown in Table 3 below.

TABLE 3

| Type | Length (octets) | Value |
|---|---|---|
| Profile | Variable | List(LINK_INFO), SEQUENCE of |
| | | (OPERATIONAL_STATE, |
| | | CHOICE(VALID_TIME_INTERVAL, |
| | | NULL)) |
| LINK_INFO | 9 | SEQUENCE of (LINK_TYPE, |
| | | LINK_WEIGHT) |
| ENUMERATED, | 1 | 1: High |
| LINK_WEIGHT | | 2: Medium |
| | | 3: Low |
| ENUMERATED, | 1 | 0: Disable (for the specified interval) |
| OPERATIONAL_STATE | | 1: Enable (interval not used) |
| LINK TYPE, | 4 | Network type representation (by |
| UNSIGNED_INT | | IANA) |
| | | 0: (Reserved) |
| | | 1: Wireless - GSM |
| | | 2: Wireless - GPRS |
| | | 3: Wireless - EDGE |
| | | 15: Ethernet |
| | | 18: Wireless - Other |
| | | 19: Wireless - IEEE 802.11 |
| | | 22: Wireless - CDMA2000 |
| | | 23: Wireless - UMTS |
| | | 24: Wireless - CDMA2000 - HRPD |
| | | 27: Wireless - IEEE 802.16 |
| | | 28: Wireless - IEEE 802.20 |
| | | 29: Wireless - IEEE 802.22 |
| VALID_TIME_INTERVAL, | 4 | Each octet may be 0x00 to 0xff |
| UNSIGNED_INT | | |

The sequence information in the LINK_INFO information element shown in Table 3 may be ordered in a decreasing order of preference such that the first network specified is the preferred network. For the ENUMERATED, OPERATIONAL_STATE information element, an interval value of zero or null indicates an infinite interval.

FIG. 12 is a diagram of an example MIH_CONFIGURE_PROFILE response message 1200. The MIH_CONFIGURE_PROFILE response message 1200 may contain a header 1210 and a payload 1220. The header 1210 may contain an MIH Header Fixed Field 1225, a Source Identifier 1230 for sending an MIHF identity (ID), or a Destination Identifier 1235 for receiving an MIHF ID. The payload 1220 may contain a Status TLV information element 1240 that indicates success or failure.

In the information service example, the MIH_CAPABILITY_DISCOVER request/response messages may be modified such that the MIH server discovers whether the MIH client supports dynamic mobile profile configuration. The MIH server may include a PROFILE_INFORMATION information element in the MIH_CAPABILITY_DISCOVER response message if the MIH client has advertised that it supports dynamic mobile profile configuration in the MIH_CAPABILITY_DISCOVER request message.

Alternatively, the MIH_GET_INFORMATION response message may be modified such that the MIH server may use the response message to send the new mobile profile information to the MIH client. The response may be sent as an unsolicited message that is not associated to a request. Standard encodings, such as binary, RDF data, RDF schema and RDF schema URL may optionally be used.

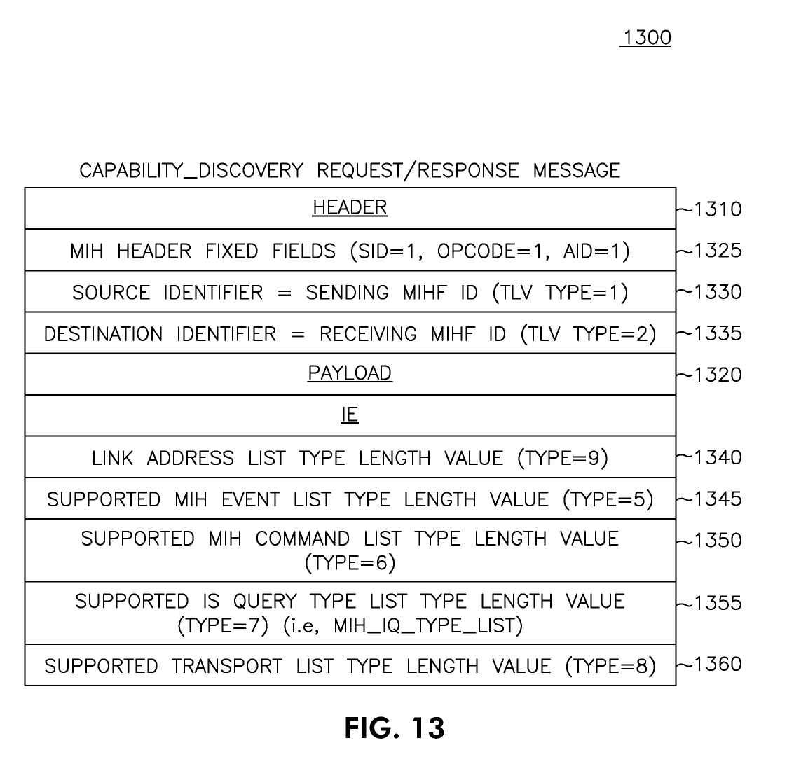

FIG. 13 is a diagram of an example CAPABILITY_DISCOVERY request/response message 1300. The CAPABILITY_DISCOVERY request/response message 1300 may contain a header 1310 and a payload 1320. The header 1310 may contain an MIH Header Fixed Field 1325, a Source Identifier 1330 for sending an MIHF identity (ID), or a Destination Identifier 1335 for receiving an MIHF ID. The payload 1320 may contain at least one of the following information elements: a Link Address List Type Length Value (TLV) 1340 that represents a link address for a specific network type, a Supported MIH Event List TLV 1345 that indicates supported MIH events for a link, a Supported MIH Command List TLV 1350 that indicates support for modified MIH commands, a Supported IS Query Type List TLV 1355 that indicates support for information services query for a link, and a Supported Transport List TLV 1360 that indicates transport options for MIH services for a link. Referring to FIG. 13, the Supported IS Query Type List TLV 1355 may indicate support for modified MIH query, for example an MIH_IQ_TYPE_LIST IE. The MIH_IQ_TYPE_LIST IE may be 8 octets in length and contain the following bitmap values as shown in Table 4 below. The MIH_IQ_TYPE_LIST may include a TYPE_IE_PROFILE_INFORMATION bit to indicate that mobile profile configurability is supported.

TABLE 4

| Bit | Bitmap Value |
|---|---|
| Bit 0 | BINARY |
| Bit 1 | RDF_DATA |
| Bit 2 | RDF_SCHEMA_URL |
| Bit 3 | RDF_SCHEMA |
| Bit 4 | TYPE_IE_NETWORK_TYPE |
| Bit 5 | TYPE_IE_OPERATOR_IDENTIFIER |
| Bit 6 | TYPE_IE_SERVICE_PROVIDER_IDENTIFIER |
| Bit 7 | TYPE_IE_ACCESS_NETWORK_IDENTIFIER |
| Bit 8 | TYPE_IE_ROAMING_PARTNERS |
| Bit 9 | TYPE_IE_COST |
| Bit 10 | TYPE_IE_NETWORK_SECURITY |
| Bit 11 | TYPE_IE_NETWORK_QOS |
| Bit 12 | TYPE_IE_NETWORK_DATA_RATE |
| Bit 13 | TYPE_IE_NETWORK_IP_CONFIG_METHODS |
| Bit 14 | TYPE_IE_NETWORK_CAPABILITIES |
| Bit 15 | TYPE_IE_LIST_SUPPORTED_LCP |
| Bit 16 | TYPE_IE_POA_MAC_ADDRESS |
| Bit 17 | TYPE_IE_POA_LOCATION |
| Bit 18 | TYPE_IE_POA_CHANNEL_RANGE |
| Bit 19 | TYPE_IE_POA_SYSTEM_INFORMATION |
| Bit 20 | TYPE_IE_POA_SUBNET_INFORMATION |
| Bit 21 | TYPE_IE_POA_IP_ADDRESS |
| Bit 22-62 | (Reserved) |
| Bit 63 | TYPE_IE_PROFILE_INFORMATION |

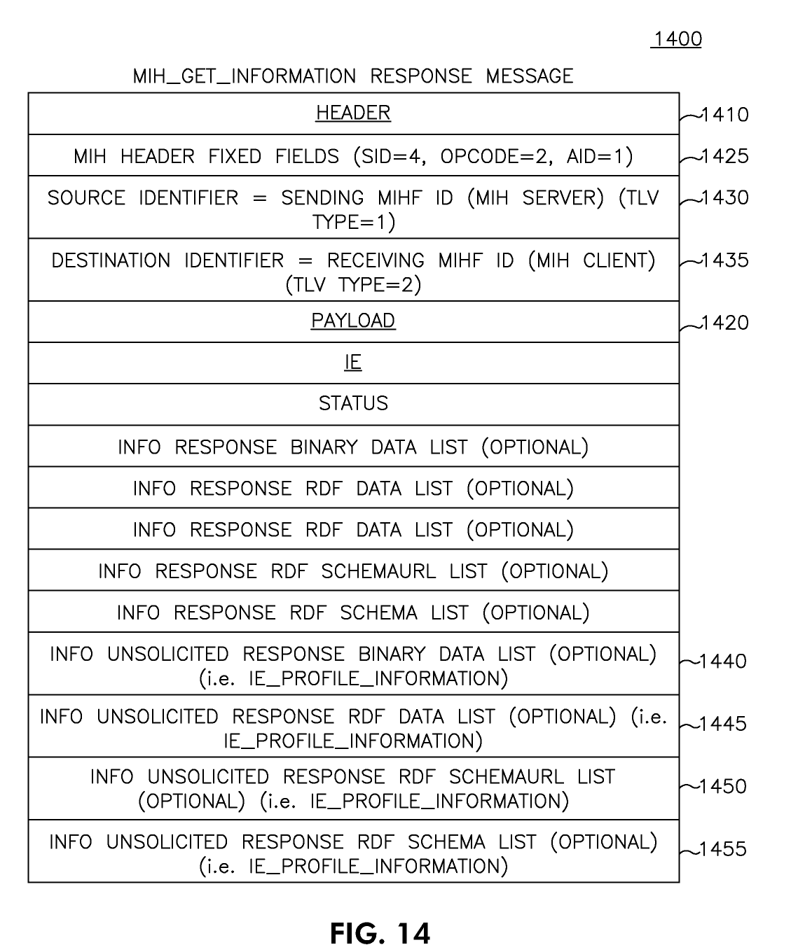

FIG. 14 is a diagram of an example MIH_GET_INFORMATION response message 1400. The MIH_GET_INFORMATION response message 1400 may contain a header 1410 and a payload 1420. The header 1410 may contain an MIH Header Fixed Field 1425, a Source Identifier 1430 for sending MIHF identity (ID), or a Destination Identifier 1435 for receiving MIHF ID. The payload 1420 may contain at least one of the following information elements: an InfoUnsolicitedResponseBinaryDataList 1440 that represents unsolicited binary information, an InfoUnsolicitedResponseRDFDataList 1445 that represents unsolicited RDF information, an InfoUnsolicitedResponseRDFSchemaURLList 1450 that represents unsolicited URL of RDF information, and an InfoUnsolicitedResponseRDFSchemaList 1455 that represents unsolicited RDF schema information. These unsolicited response information elements may be indicated by an IE_PROFILE_INFORMATION information element that contains the MIH client mobile profile information, as defined in Table 3.

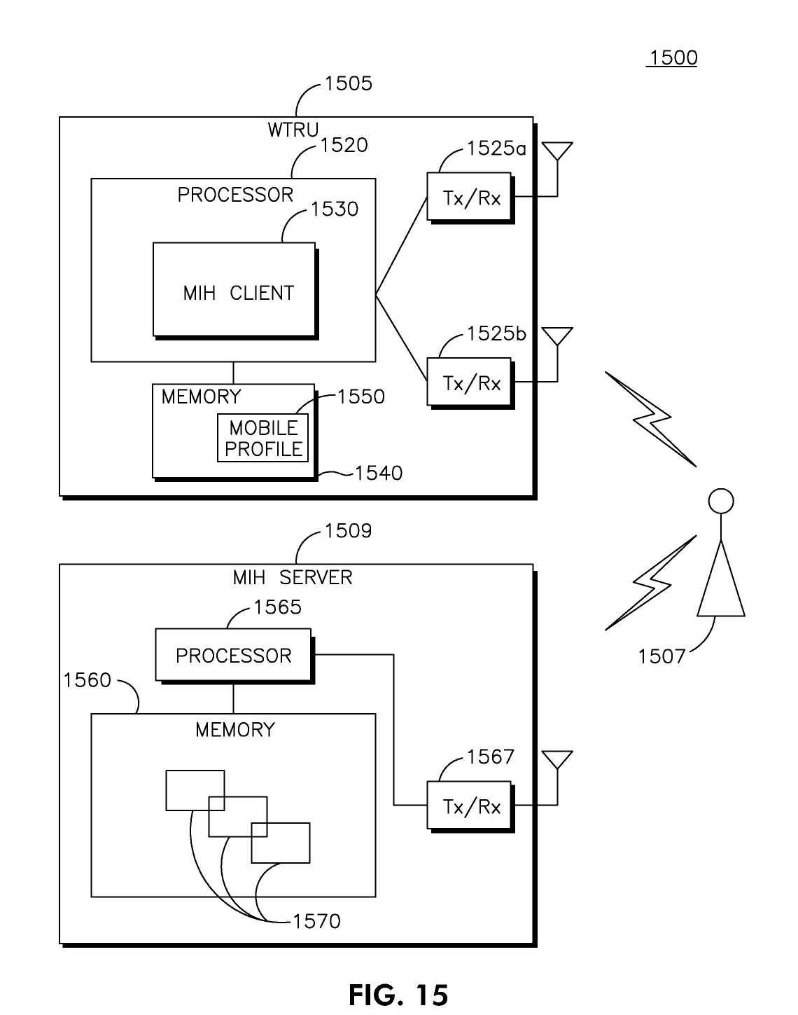

FIG. 15 is a block diagram of an example system 1500 configured to support dynamic mobile profile functionality as described in the examples provided above. The system 1500 comprises a WTRU 1505, an AP 1507, and an MIH server 1509.

As shown in FIG. 15, the WTRU 1505 includes a processor 1520, at least two transceivers (1525a, 1525b), and a memory 1540 configured to store a mobile profile 1550. The processor 1520 is configured to operate an MIH client 1530, and is attached to each of the transceivers 1525a, 1525b. The MIH client 1530 is configured to carry out MIH related processes, including receiving a link status from a device driver, receiving a measurement of link quality, generating and collecting quality reports, sending the quality reports to the MIH server (not shown) over the MIH message transport interface using the socket layer, receiving an updated mobile profile parameter, and receiving a decision to perform a handover from the MIH server. Alternatively, the MIH client may also autonomously make the handover decision and/or dynamically update the mobile profile parameter.

The MIH server 1509 includes a memory 1560, a processor 1565, and a transceiver 1567. The memory 1560 is configured to store multiple mobile profiles 1570, for example, mobile profile WTRU1, mobile profile WTRU2, etc. The processor 1565 may be configured, for example, to determine whether to switch a WTRU to a different network, adjust a network weight, or perform any other similar action.

Updating the mobile profile parameter may be based on handover statistics. The preferred network may be changed dynamically based on these statistics. One example of these statistics include the number of handovers that occurred in a predetermined amount of time. If a WTRU has experienced many handovers, a subsequent handover may be less favored, especially if the handover is not due to a loss of connection, but for load balancing or optimization. For example, if a WTRU had several handovers between a WLAN and a cellular network, and the preferred network is the WLAN, it is possible that the WTRU is moving along spotty coverage of the WLAN, and therefore it is desirable to decrease the preference weight for the WLAN, or even change the preferred network to cellular.

Another example of these statistics may be based on the WTRU's traffic pattern. The statistics of the WTRU's traffic pattern during a predetermined amount of time may define the WTRU's preferred network. These statistics may include transactions or packets of voice/data traffic, session originating/terminating, or roaming, etc. For example, if a WTRU is transmitting/receiving mostly data, then it should have more weight for data centric networks. On the other hand, if the WTRU is active on CS calls, it may have more weight on cellular networks.

The dynamic mobile profile may be based on the WTRU's location, for example, through GPS capabilities. The WTRU may send its location information to the MIH server. The MIH server may then check the regional network deployment map to dynamically change the WTRU's preferred network if the previous preferred network is unavailable in the WTRU's current location.

The dynamic mobile profile may be based on time. For many mobile users, the pattern of each day is predictable. For example, the mobile user may in a home WLAN in the morning and evening hours, in cellular coverage while on the road, and in WiMAX coverage while at work. The WTRU mobile profile may be changed according to the mobile user's pattern of life style at different times of the day.

Although features and elements are described above in particular combinations, each feature or element may be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A Media Independent Handover (MIH) method for a wireless transmit/receive unit (WTRU) comprising:
scanning for a preconfigured preferred network;
receiving a request to change the preconfigured preferred network to a non-preferred network; and
setting the preconfigured preferred network to the non-preferred network.

2. The method of claim 1, wherein the request is an MIH_CONFIGURED_PROFILE_REQ primitive.

3. The method of claim 1, wherein the request is a handover request.

4. The method of claim 2 further comprising:
setting a weight factor for the preconfigured preferred network.

5. The method of claim 4, wherein the MIH_CONFIGURE PROFILE_REQ primitive indicates a lower preference for the preconfigured preferred network.

6. A wireless transmit/receive unit (WTRU) comprising:
a receiver configured to receive a request to change a preconfigured preferred network to a non-preferred network; and
a media independent handover (MIH) client configured to
scan for the preconfigured preferred network, and
set the preconfigured preferred network to the non-preferred network.

7. The WTRU of claim 6, wherein the receiver is configured to receive an MIH_CONFIGURED_PROFILE_REQ primitive.

8. The WTRU of claim 6, wherein the receiver is configured to receive a handover request.

9. The WTRU of claim 6, wherein the receiver is configured to receive a primitive that indicates a lower preference for the preconfigured preferred network.

10. The WTRU of claim 9, wherein the MIH client is further configured to set a weight factor for the preconfigured preferred network.

11. A Media Independent Handover method for a wireless transmit/receive unit comprising:
receiving a mobile profile on a current network;
determining whether a mobile profile parameter has changed; and
performing an action based on the received mobile profile on a condition that a mobile profile parameter has changed.

12. The method of claim 11, wherein the mobile profile parameter is a preferred network, an associated weight, or an operational state.

13. A Media Independent Handover method for a wireless transmit/receive unit comprising:
receiving a mobile profile on a current network, the mobile profile indicating a preferred network;
determining whether the preferred network has changed;
determining whether an associated weight has changed on a condition that the preferred network has not changed; and
scanning at a predetermined interval to detect the preferred network on a condition that the current network is not the preferred network.

14. The method of claim 13 further comprising:
starting a scan timer on a condition that the preferred network is not detected; and
triggering a handover to the preferred network on a condition that the preferred network is detected.

15. The method of claim 13 further comprising:
determining whether the associated weight has increased;
increasing the predetermined scan interval on a condition that the associated weight has increased; and
decreasing the predetermined scan interval on a condition that the associated weight has not increased.

16. A wireless transmit/receive unit (WTRU) comprising:
a receiver configured to receive a mobile profile on a current network;
a media independent handover (MIH) client configured to
determine whether a preferred network has changed,
determine whether an associated weight has changed on a condition that the preferred network has not changed, and
scan at a predetermined interval to detect the preferred network on a condition that the current network is not the preferred network.

17. The WTRU of claim 16, wherein the MIH client is further configured to start a scan timer on a condition that the preferred network is not detected, and trigger a handover to the preferred network on a condition that the preferred network is detected.

18. The WTRU of claim 16, wherein the MIH client is further configured to determine whether the associated weight has increased, increase the predetermined scan interval on a condition that the associated weight has increased, and decrease the predetermined scan interval on a condition that the associated weight has not increased.
